(19) United States
(12) Patent Application Publication
(10) Pub. No.: US 2005/0119948 A1
(43) Pub. Date: Jun. 2, 2005

(54) System and method for presenting a synthesized interface to a product catalog

(76) Inventor: Timothy A. Musgrove, Morgan Hill, CA (US)

Correspondence Address: NIXON PEABODY, LLP, 401 9TH STREET, NW, SUITE 900, WASHINGTON, DC, 20004-2128, US

(21) Appl. No.: 10/952,478

(22) Filed: Sep. 29, 2004

Related U.S. Application Data
(60) Provisional application No. 60/506,753, filed on Sep. 30, 2003.

(51) Int. Cl. G06F 17/60

(52) U.S. Cl. 705/27; 705/26

(57) ABSTRACT

A method and system for displaying product offerings from a product catalog stored as a database in a memory device. The product catalog includes product information records indicating product characteristics and product prices from specific merchants. The method includes receiving a query for product information, processing the query to determine matching product information records in the catalog that satisfy the query, clustering the product information records in accordance with the identity of the product in the product information records and presenting the product information records as a displayable presentation of product offerings including a product identity, a merchant, and a product price. The product offerings are grouped in accordance with said clustering step.

### COPYRIGHT NOTICE

This application contains content protected by copyright. Applicant permits the creation of verbatim copies of this application. All other copyright and other proprietary rights are reserved.

### BACKGROUND

The invention relates to an interface to a product catalog, such as product catalogs used for providing product information in connection with Internet comparison shopping web sites.

The Internet, and more particularly the web, has become ubiquitous. The web is a subset of the Internet utilizing Hypertext Transfer Protocol (HTTP) and Hypertext Markup Language) HTML to present information to devices having a web browser. The general nature and technical function of the web is of course well known. Almost every product manufacturer and merchant has a web presence though which a user can obtain product information and, in many cases, purchase products on line through a secure transaction protocol. Further, web-based “shopping portals” or “comparison shopping sites” are well known and provide a unified interface for allowing a user, such as a shopper, to browse various products and/or product offerings from various merchants. The information related to the products is generally stored in a database, known as a “product catalog”. The user can browse by selecting products or product categories and view product information from the database. Ordinarily, the user at some point is directed to a specific merchant web site(s) for purchase of desired products or more detailed information related to products. Note that the phrase “product offering”, as used herein, refers to a specific product and price combination from a merchant. For example, two merchants might offer the same product, at the same or different prices. Such a situation would encompass a single product and two product offerings.

When comparison shopping sites first became widely used, the comparison shopping site ordinarily was compensated by the merchants through a fixed fee, for example a monthly fixed fee, for providing access to a merchant's product offering information on the comparison shopping web site. However, it soon became apparent to merchants that merely having their product offering information on the comparison shopping site was not, in and of itself, of value to the merchants. Accordingly, the most common business model for comparison shopping sites moved from a fixed fee arrangement to a “payment per lead” arrangement, sometimes referred to as a “cost-per-click” (CPC) model. In such a model, the merchant pays a predetermined fee to the comparison shopping site for each user that is directed to the merchant's web site form the comparison shopping web site. A direction of a user from the comparison shopping site to a merchant is referred to as a “lead” herein. Merchants often compile lead metrics to indicate the quality of leads generated from a comparison shopping site. For example, it is known to measure how many leads directly result in a sale as well as other metrics. Of course, merchants are willing to pay more per lead for high quality leads, e.g., leads more likely to generate a sale, than for relatively low quality leads.

Generally, there are two types of interfaces used in comparison shopping sites. One type of interface is based on unique Universal Product Identifications (UPIDs). Ideally each product has a unique UPID that is used by a database engine for sorting. This type of interface is referred to a “product-based” interface herein. The other type of interface is based on product offerings and does not necessarily use UPIDs. This type of interface is referred to as an “offerings-based” interface herein. As will become apparent from the description below, the two types of interfaces provide significantly different user experiences and each has advantages and drawbacks. Further, the back end mechanisms for driving each interface are significantly different and have different and, in some cases, conflicting requirements.

FIG. 1 illustrates search results 100 from a comparison shopping cite which utilizes an offerings-based interface. Such an interface is similar to that used by shopping sites such as MYSIMON.COM™, The search results 100 presented in FIG. 1 are in response to a user entering the phrase “Diablo” into a search box of the web interface. The phrase is utilized to execute a query of the underlying product database in a well known manner. Of course, the search query could be processed in any manner and using any algorithm. For example, the query could specify product characteristics other than a keyword phrase. Characteristics can include memory or operating system requirements, pricing, manufacturer, or any other characteristic of the product. For example a search could be conducted for “3 megapixel digital cameras.” The resulting presentation is a list of the various product offerings from plural merchants having records in the database that include the keywords of the search query. In the example of search results 100, the key word “diablo” was found in the title of each product. However, the keyword could have been found in other fields of the product data record. Search results 100 in this example include merchant column 110, title column 120, and price column 130.

The presentation of search results 100 is a “one product to one price” presentation. In other words, each listing in search results 100 is a product offer including a specific product, merchant, and price. It can be seen that various different products satisfying the query are presented thus facilitating comparison shopping between different products satisfying the users search criteria. However, it can also be seen that, due to inconsistencies in the product names assigned by the various merchants, it is not always clear to the user which products are actually the same products. Other than the fact that each product has the word “diablo” in its title, the user knows little about the identity of each product from search results 100. For example, the last product offer in search results 100 is for a product entitled “Diablo” and the second product offering in search results 100 is for a product entitled “Best Seller Series: Diablo”. Both offers have an identical price and thus presumably are the same product with different titles. However, the user must inquire further to be sure of this. For example, the user can visit the merchant web site for a more detailed description of the respective products by selecting the corresponding “BUY” link in column 130.

Accordingly, the user will often select a product offering and be directed to the corresponding merchant site merely to investigate if the product is the same as another product in the list. Such an action generates a lead resulting, presumably, in a specified fee being paid by the merchant to the comparison shopping cite. Note the merchant sites in this type of interface are one click away from the search results. Naturally, the offering-based interface results in a high quantity of leads. However, as noted above, the leads are often of low quality. In other words, the user often is not close to a purchase decision but is merely investigating the identity of a product.

FIG. 2a illustrates search results 200 from a comparison shopping site which utilizes a product-based interface. For example, such an interface can be found on the web site known as SHOPPER.COM™. The search results presented in FIG. 2, similar to those of FIG. 1 are also in response to a user entering the key word “diablo” into a search box of the web interface. The phrase is once again utilized to execute a query of the underlying product database in a well known manner. The resulting presentation is a list of the various products, in column 210, having records in the database including the keyword and correlated to various prices for the products in column 220. In other words, the presentation is a “one product to many prices” presentation. In particular, the underlying database for this type of catalog interface includes a UPID (Universal Product ID), or some other unique product identifier, correlated to each product offering record. Therefore, the interface groups various offerings that are for the same product, not withstanding the fact that the offerings may have different titles or other information. Of course, the process of “UPIDizing” the data base is complex and often requires that a human editor review the various product offerings and additional related information to ascertain the actual identity of a product in the product offering. The prices correspond to the various merchant product offerings for that product. To view the specific product offerings for a desired product, the user selects the product, through a mouse click for example, In search results 200, column 220 includes a “CHECK LATEST PRICES” button which permits the user to view the individual offerings for the product. The result of a product selection, by clicking the “CHECK LATEST PRICES BUTTON” for example, is illustrated in FIG. 2b. It can be seen in FIG. 2b that the individual product offerings for the selected products, “Diablo Battle Chest” in this example, are shown. Note that the presentation of FIG. 2b is similar to that of FIG. 1, except that only product offerings for a single product are shown. In other words, the interface of FIGS. 2a and 2b uses the UPIDs to segregate product offerings by product identity.

The user can then select the desired product offering, based on price, merchant reputation, or any other criteria, and be taken to the merchant web site for that offering for more information or a purchase. Note that when the user selects a product offering from the presentation shown in FIG. 2b, a lead is generated and, presumably, the comparison shopping web site is paid a specified fee for the lead from the merchant to which the lead was generated. Also, note that, in this type of interface, the merchant site is two clicks from the search results of FIG. 2a.

The product-based interface illustrated in FIGS. 2a and 2b does not generate as many leads as the interface of FIG. 1. However, it has been proven to generate higher quality leads. In other words, the leads generated by the product-based interface represent a user that is closer to a purchase decision for the product and is thus more likely to actually purchase the product from the merchant receiving the lead. Merchants naturally prefer high quality leads and are thus willing to pay a higher fee per lead for leads emanating from product-based interfaces. However, product-based interfaces are not always convenient for the user. For example, since offers are grouped and displayed by specific products, it is cumbersome to compare prices and features of similar but different products. For example, if a user is looking for a digital camera with a 5 megapixel image sensor, the user will be shown product offerings for only one such camera, the Nikon D100™ for example, at a time. If the user wants to compare product offerings for the FujiFilm Finepix™, which is also a 5 megapixel digital camera, the user must back out of the offerings display, such as that shown in FIG. 2b, for the first camera and select the second camera to view offerings for that product. Therefore. The product-based interface is effective for comparing multiple offerings of one product but is not effective for comparing product offerings of comparable but different products. Since users often are unsure of which specific product they desire, and are more likely to know characteristics of a desired product, such as imaging resolution of a camera, the product-based interface often falls short of user expectations.

There have been several attempts at combining or hybridizing the features of product-based interfaces and offering-based interfaces to obtain the advantages of each interface. However, this presents significant technical issues since the respective underlying databases for the two types of interfaces are organized and indexed in a different manner. Further, the user experience is much different for the two interfaces. Therefore, attempts at such hybridization have not yielded desirable results. One attempt at hybridization is to present two separate displays for a search query. For example, a product-based presentation is displayed in a main window of a web page and an offering-based presentation is displayed in a frame above or to the side of the main window. This configuration results in a confusing user experience and does not provide the advantages of the two types of interfaces. In particular, because of the vastly different metaphors and resulting navigation of the interfaces, the user will ordinarily merely use the interface that they prefer. This does potentially increase the user experience by providing a choice of interfaces. However, the reduced screen real estate for the desired interface results in an experience that is not as desirable as if the user had merely picked a comparison shopping site have the preferred interface. Further, the resulting leads are either high quality/low quantity or high quantity/low quality based on the interface selected by the user. This situation makes it difficult for the merchant to judge the quality of leads. The resulting uncertainty complicates the lead fee negotiation process between the merchant and the comparison shopping site.

Another known method of combining the two interfaces is to present some product categories with one type of interface and some product categories with the other type of interface. For example, digital cameras could have an offering-based interface and vacuum cleaners could have a product-based interface. The result is that, once again, the advantages and limitations of each interface are still present, only in an alternative fashion. Accordingly, this type of hybrid interface has the same problems as the hybrid interface described above. Further, the user experience becomes inconsistent resulting in a decreased efficiency on the part of the user. It can be seen that prior attempts at hybridizing comparison shopping site user interfaces have not successfully synthesized the interfaces in a manner that emphasizes the advantages of each interface while minimizing the disadvantages of each interface.

### SUMMARY OF THE INVENTION

An aspect of the invention is a method for displaying product offerings from a product catalog stored in a memory device, the product catalog including product information records indicating product characteristics and product prices from specific merchants. The method comprises receiving a query for product information, processing the query to determine matching product information records in the catalog that satisfy the query, clustering the product information records in accordance with the identity of the product in the product information records, and presenting the product information records as a displayable presentation of product offerings including a product title, a merchant, and a product price. The product offerings are grouped in accordance with said clustering step.

### BRIEF DESCRIPTION OF THE DRAWING

The invention is described through a preferred embodiment and the attached drawing in which;

FIG. 1 is a display of search results in an offerings-based interface;

FIG. 2a is a display of search results in a product-based interface;

FIG. 2b is a display of product offerings of a product selected from the search results of FIG. 2a;

FIG. 3 is a display of search results of a first example of the preferred embodiment;

FIG. 4 is a display of search results of a second example of the preferred embodiment;

FIG. 5 is a display of search results of a third example of the preferred embodiment; and

FIG. 6 is a schematic illustration of a database in accordance with the preferred embodiment;

### DETAILED DESCRIPTION

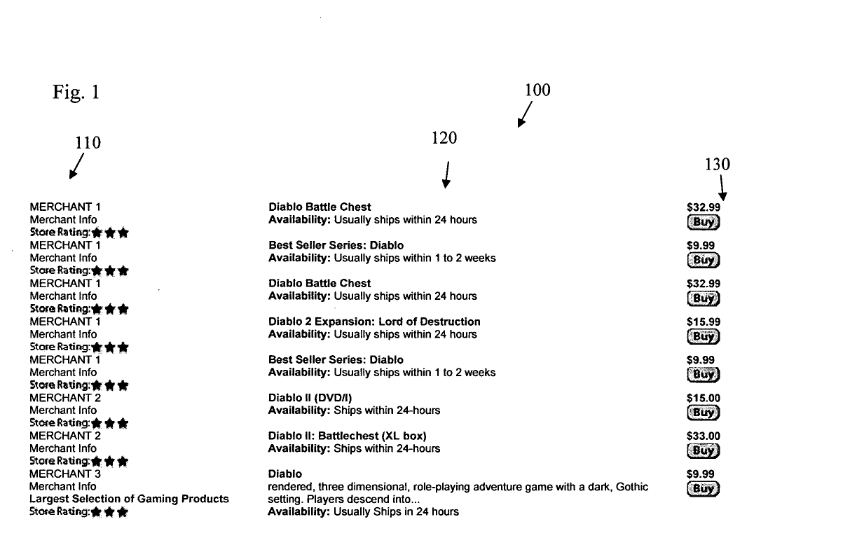

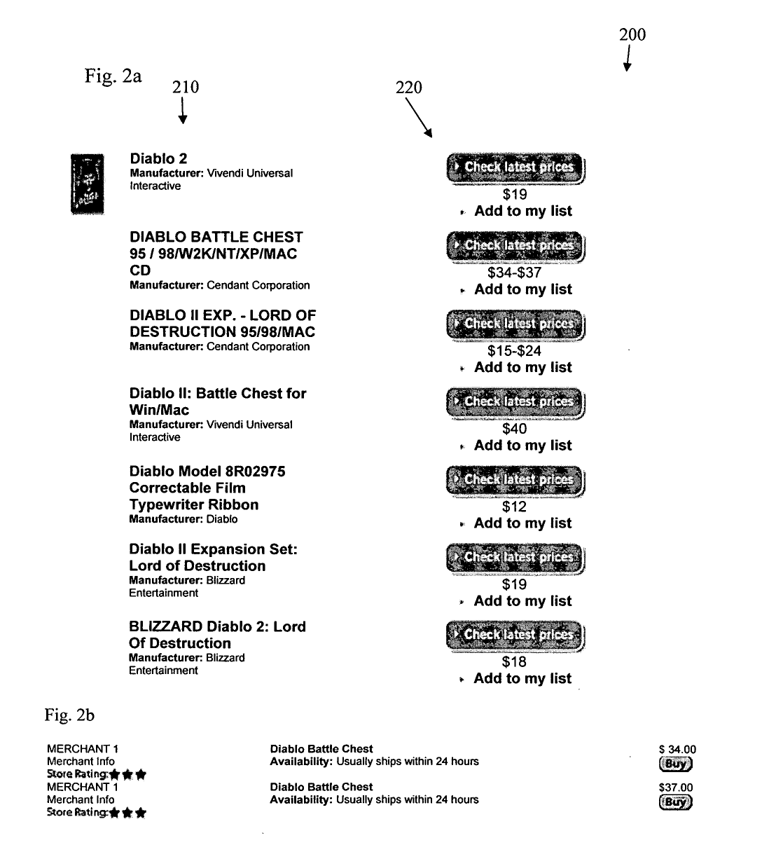

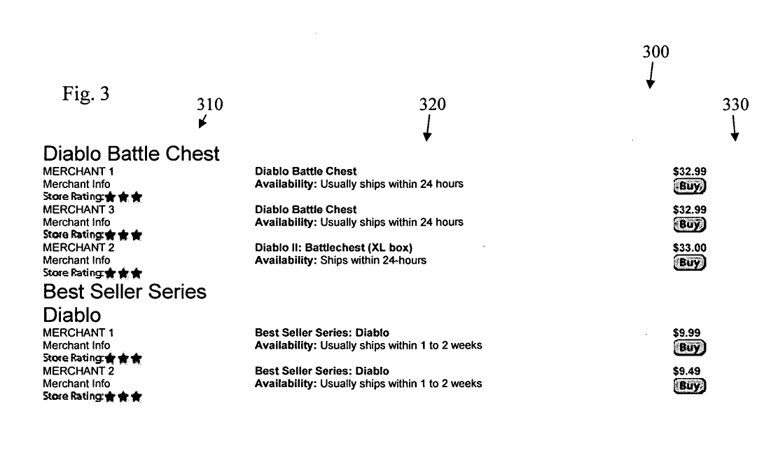

FIG. 3 illustrates search results 300 of a user interface and product catalog of an embodiment of the invention. It will be seen that search results 300 synthesize the desirable aspects of each of the product-based and offering-based interfaces described above in a manner that capitalizes on the advantages of each interface without introducing the disadvantages of previous attempts at hybridizing such interfaces. Search results 300 include product offers consisting of respective merchants in column 310, product titles in column 320, and product prices in column 330. At first glance, this is similar to search results 100 of FIG. 1. However, in search results 300, the product offerings are also clustered in groups of identical products, notwithstanding the differing titles of the products. In the example of search results 300, two different products matched the search criteria, “Diablo Battle Chest” and “Best Seller Series Diablo”. Because the interface presents products as offers, the user is one click away from the merchant site for purchasing a product (similar to interface 100) while able to view offers for various products that are similar. Further, the arrangement of search results 300 permits the user to easily ascertain which products are the same and which are different products that still match the search query without the need to visit the merchant purchase site to obtain more information (and thus generate a low quality “lead”).

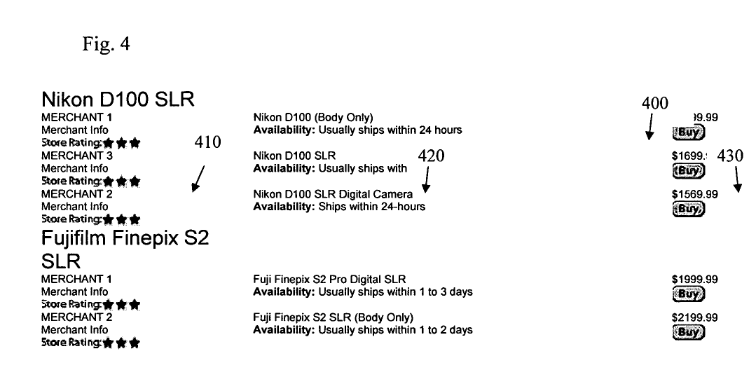

FIG. 4 illustrates another example of search results in accordance with an embodiment of the invention. In FIG. 4, the search results are presented in response to a query specifying the feature of “5 megapixel digital cameras”. As noted above, such an example is illustrative because users often do not know the name of a desired product but know a feature(s) that they desire in a product. In this example, an imaging resolution of 5 megapixels is the desired feature. As illustrated in FIG. 4, each product offering for two different cameras that satisfied the search results are illustrated. Search results 400 include product offerings consisting of respective merchants in column 410, product titles in column 420, and product prices in column 430. The product offerings are clustered by product identity. This display permits the user to view the product offers and compare similar products, while still being only one click away from a purchase web page. The user need not further research product offerings to ascertain if they are for the same product. Further, the user can still view offers for comparable products that match the search criteria.

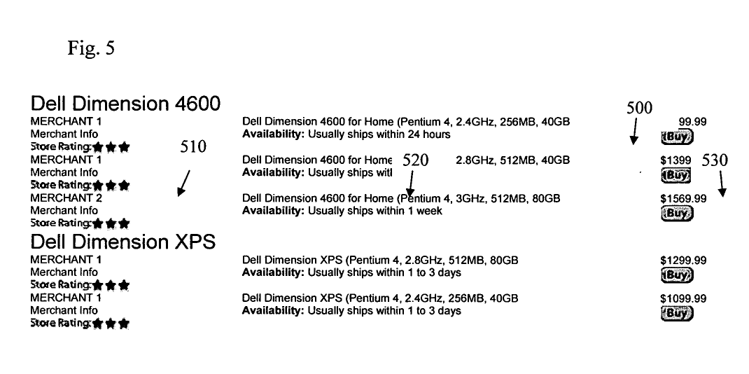

FIG. 5 illustrates another example of search results in accordance with an embodiment of the invention. In FIG. 5, the search results are presented in response to a query of “Dell Dimension”. Often products such as personal computers are sold under the same product name in various configurations, such as combinations of processor speed and memory. Search results 500 include product offerings consisting of respective merchants in column 510, product titles in column 520, and product prices in column 530. The product offerings are clustered by product identity. It can be seen that the offerings for various configurations of each product, Dell Dimension 4600 for example, are clustered together as variations of identical products for ease of comparison while still presenting the advantages of the interface discussed above. In the example of FIG. 5, each product offering is for a different configuration. However, plural offerings of the same configuration can be presented also.

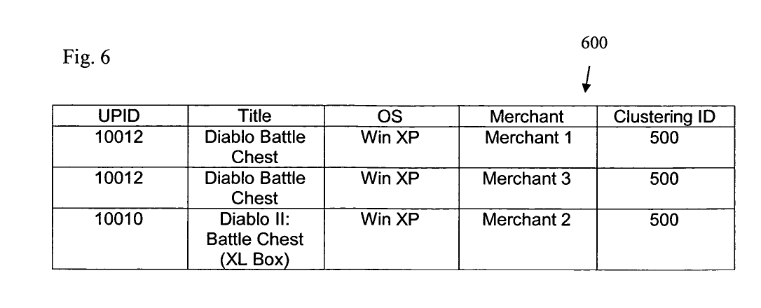

FIG. 6 illustrates an example of the structure of product records in the database of the product catalog of the preferred embodiment. Database 600 includes plural product records represented as rows in FIG. 6. Each product record includes a UPID in field 610, product characteristics (in this example a product title and operating system requirement) in field 620, a merchant name or other merchant identifier in field 630, and a clustering ID in field 640. Note that the UPID is a unique identifier assigned to each product. The clustering ID, on the other hand, is an identifier assigned to one or more similar products that are desired to be clustered in the search results for comparison by the user in making and informed product selection. In the example of FIG. 6, the first two data records are for identical products. The third data record is for a different product, as indicated by the corresponding UPIDs. However, the clustering ID for the third product is the same as that of the first two products in the database. This is the case because it has been determined that the third product is similar to the first two products, i.e. is a product that a user might want to compare with the first two products. The use of a clustering ID in addition to, or in lieu of, the UPID permits the interface of the preferred embodiment to display product offerings clustered in various ways, and not just grouped by the UPID, i.e. by the specific product.

Clustering IDs, and thus clustering arrangements of search results can be determined in various ways. For example, a human editor can review the product records and determine desired clustering. Also, clustering can be accomplished in an automated manner using computational linguistics or other methods or algorithms. Clustering can be accomplished at various levels in a tree-like manner. For example, cluster IDs can be combined into a group. In other words, it can be predetermined that more than one cluster ID should be presented in the same cluster in certain or all search results.

The invention can be applied to any type of product catalog. The products displayed by the invention can be any type of product, such as computers, household appliances, cameras, and the like. Further, the products can be goods or services.

Typically, the invention will be implemented in a client server environment, such as Web servers and client computers running web browsers. The client computer can be associated with a user and can be used to submit queries to the server. Search results can then be displayed in the browser window of the client. However, the invention can be implemented by any type of computer system including one or more computing devices in a networked or standalone architecture. Computing devices can include personal computers, mobile phones, PDAs, thin clients, or the like. Any type of communication channels and any type of communication protocols can be used. Further, the catalog can be stored as a database in a memory device of a computer in any format. The term “database” as used herein, refers to any collection of data, such as a lookup table, a flat file database, a relational database, plural records, or the like.

The invention has been described through a preferred embodiment and various examples. However, it will be apparent to one of skill in the art that various modifications can be made without departing from the scope of the invention, as defined in the appended claims and legal equivalents.

1. A method for displaying product offerings from a product catalog stored as a database in a memory device, the product catalog including product information records indicating product characteristics and product prices from specific merchants, said method comprising:
receiving a query for product information;
processing the query to determine matching product information records in the catalog that satisfy the query;
clustering the product information records in accordance with the identity of the product in the product information records;
presenting the product information records as a displayable presentation of product offerings including a product identity, a merchant, and a product price, wherein said product offerings are grouped in accordance with said clustering step.

2. A method as recited in claim 1, wherein at least some of the product information records include a clustering ID indicative of a cluster to which the respective product information records belong and wherein said clustering step comprises grouping the product information records in accordance with the clustering IDs.

3. A method as recited in claim 1, wherein at least some of said product offerings comprise a direct link to a web site at which the product can be purchased in accordance with the product offering.

4. A method as recited in claim 1, wherein the product characteristic in the query comprises a keyword.

5. The method as recited in claim 5, wherein said keyword comprises a word or phrase that is part of a product name in the selected product records.

6. A method as recited in claim 3, wherein said presentation is HTML data and said presenting step comprises displaying the presentation as a display in a web browser.

7. A method as recited in claim 3, wherein at least some of the product information records do not include a clustering ID and wherein said clustering step comprises clustering together all product information records without a clustering ID.

8. A method as recited in claim 2, wherein clustering IDs are unique to a cluster of product information records.

9. A method as recited in claim 2, wherein at least one cluster of product information records encompasses plural clustering IDs.

10. A method as recited in claim 1, wherein said product offerings are grouped so that different configurations of similar products are displayed as a group on said display screen.

11. A method as recited in claim 6, wherein said product offerings are grouped so that products in a product line are displayed as a group in said display.

12. A method as recited in claim 6, wherein said product offerings are grouped so that identical products are displayed as a group in said display.

13. A database stored on a computer readable storage medium and defining a product catalog from which product offerings can be displayed, the database including plural product information records, each of said product information records comprising:
at least one product characteristic field containing data indicating a product characteristic;
at least one price field containing data indicating a product price;
at least one merchant filed containing data indicating a merchant form which the product can be purchased;
at least one UPID field indicating a unique product ID for the product; and
at least one clustering ID field indicating a cluster for the product, said data in said clustering ID field being readable by a computer to permit the computer to group the product records in accordance with predefined clusters that are not unique to each product.
